(19) United States
(12) Patent Application Publication
(10) Pub. No.: US 2020/0368726 A1
(43) Pub. Date: Nov. 26, 2020

(54) ONE STEP LIQUID-TO-METAL HIGH SURFACE AREA CATALYSTS VIA LOW TEMPERATURE REDUCTION

(71) Applicant: The University of Toledo, Toledo, OH (US)

(72) Inventor: John A. Setlock, Toledo, OH (US)

(73) Assignee: The University of Toledo, Toledo, OH (US)

(21) Appl. No.: 16/767,461

(22) PCT Filed: Dec. 4, 2018
(86) PCT No.: PCT/US2018/063797

§ 371 Date: May 27, 2020

Related U.S. Application Data
(60) Provisional application No. 62/595,767, filed on Dec. 7, 2017.

(51) Int. Cl. B01J 23/42; B01J 23/83; B01J 35/04; B01J 35/10; B01J 37/02; B01J 37/08; H01M 4/92; B01D 53/94

(52) U.S. Cl. CPC B01J 23/42; B01J 23/83; B01J 35/04; B01J 35/1009; B01J 35/1014; B01J 37/0213; B01D 2255/9207; B01J 37/0215; B01J 37/0236; B01J 37/088; H01M 4/925; B01D 53/94; B01D 2255/1021; B01J 37/0203

(57) ABSTRACT

High surface area metal catalysts, and methods of making and using the same, are described.

### RELATED APPLICATIONS

This application claims priority to U.S. Provisional Application No. 62/595,767 filed under 35 U.S.C. § 111(b) on Dec. 7, 2017, the disclosure of which is incorporated herein by reference in its entirety.

### STATEMENT REGARDING FEDERALLY SPONSORED RESEARCH

This invention was made with Government support under contract NNC13BA10B awarded by NASA. The Government has certain rights in the invention.

### BACKGROUND

Metal catalysts, such as platinum catalysts, are used in a wide variety of devices. It would be advantageous to develop new and more efficient metal catalysts, as well as improved methods of making metal catalysts.

### SUMMARY

Also provided is a method of preparing a catalyst, the method comprising contacting a metal salt or a solution comprising the metal salt with a reducing agent comprising corn syrup to produce a reaction mixture, optionally boiling at least some liquid off the reaction mixture to alter the viscosity of the reaction mixture, applying the reaction mixture to a substrate to produce a coated or infiltrated substrate, heating the coated or infiltrated substrate to a temperature of at least about 200° C. for a period of time to produce a metal catalyst.

In certain embodiments, the metal salt comprises hexachloroplatinate or a nitrate salt. In certain embodiments, the solution is prepared by dissolving the metal in aqua regia. In certain embodiments, the solution comprises methanol. In particular embodiments, the metal is platinum. In certain embodiments, the metal comprises platinum, palladium, silver, gold, nickel, copper, or alloys or mixtures thereof. In certain embodiments, the metal consists essentially of platinum. In certain embodiments, the metal is not silver.

In certain embodiments, the metal catalyst comprises two or more metals. In certain embodiments, the metal catalyst further comprises at least one oxide. In particular embodiments, the oxide comprises cerium oxide, gadolinium oxide, or yttria stabilized zirconia. In certain embodiments, the metal catalyst comprises a mixture of two or more catalyst materials selected from the group consisting of platinum, palladium, nickel, silver, cerium oxide, gadolinium oxide, and yttria stabilized zirconia. In certain embodiments, the metal catalyst comprises Ni-doped yttria stabilized zirconia. In certain embodiments, the metal catalyst comprises a cermet.

In certain embodiments, the corn syrup is light corn syrup. In certain embodiments, the corn syrup is dark corn syrup. In certain embodiments, the corn syrup comprises a mixture of light corn syrup and dark corn syrup. In certain embodiments, the corn syrup further includes one or more of flavorings, salt, molasses, Refiner's syrup, colorings, and preservatives. In certain embodiments, the corn syrup does not consist of dextrose.

In certain embodiments, the period of time ranges from about 5 minutes to about 30 minutes. In certain embodiments, the period of time is about 15 minutes.

In certain embodiments, the coated or infiltrated substrate is allowed to dry for a second period of time prior to the heating. In particular embodiments, the coated or infiltrated substrate is allowed to dry for about 2 hours at a temperature of about 80° C.

In certain embodiments, the metal catalyst comprises a metal foam having a surface area of at least about 5 m²/g. In certain embodiments, the metal catalyst comprises a metal foam having a surface area of at least about 8 m²/g. In certain embodiments, the metal catalyst comprises a metal foam having a surface area of at least about 10 m²/g.

In certain embodiments, the metal catalyst is allowed to cool.

In certain embodiments, the substrate comprises a metal, an alloy, a plastic, or a ceramic. In certain embodiments, the substrate comprises a solid electrolyte. In certain embodiments, the substrate comprises a ceramic material having a honeycomb structure. In certain embodiments, the substrate is porous, and the precursor solution infiltrate the pores of the substrate.

In certain embodiments, the method further comprises using the metal catalyst in a fuel cell or a catalytic converter. In particular embodiments, the fuel cell is a polymer electrolyte membrane fuel cell (PEMFC). In particular embodiments, the fuel cell is a solid oxide fuel cell (SOFC). In particular embodiments, the fuel cell is a solid oxide electrolyzer cell (SOEC).

In certain embodiments, the method further comprises heating the metal catalyst in a reducing atmosphere in order to reduce oxides to metal. In particular embodiments, the reducing atmosphere comprises about 5% hydrogen and about 95% nitrogen.

Further provided is a metal catalyst made by the method described herein. Further provided are fuels cells comprising the metal catalyst, and catalytic converters comprising the metal catalyst.

Further provided is a kit for making a catalyst, the kit comprising a first container housing corn syrup, and a second container housing a source of metal. In certain embodiments, the kit further comprises a substrate. In certain embodiments, the kit comprises a metal precursor solution.

Further provided is a method of preparing a catalyst, the method comprising contacting a metal salt or a solution comprising the metal salt with a reducing agent comprising a mixture of two or more sugars to produce a reaction mixture, optionally boiling at least some liquid off the reaction mixture to alter the viscosity of the reaction mixture, applying the reaction mixture to a substrate to produce a coated or infiltrated substrate, and heating the coated or infiltrated substrate to a temperature of at least about 300° C. for a period of time to produce a metal catalyst. In certain embodiments, the mixture of two or more sugars comprises a mixture of dextrose and cane sugar. In particular embodiments, the mixture comprises about 20% dextrose. In particular embodiments, the mixture comprises about 50% dextrose.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIGS. 1A-1B: Flow chart (FIG. 1A) and pictoral flow chart (FIG. 1B) of non-limiting example embodiments of a method for making a metal catalyst.

FIG. 2: Photograph of a foaming reaction mixture.

FIGS. 3A-3E: SEM images of platinum foam at 275× (FIGS. 3A-3B), 200× (FIG. 3C), 840× (FIG. 3D), and 800× (FIG. 3E) magnification.

FIGS. 4A-4B: Photographs of platinum foam at 20× (FIG. 4A) and no (FIG. 4B) magnification, clearly showing the porous structure of the foam.

FIGS. 5A-5B: SEM images at higher magnification (4900× (FIG. 5A) and 6600× (FIG. 5A) magnification, showing the porous nanostructure of the platinum foam.

FIGS. 6A-6G: SEM image of a freezecast structure infiltrated with a platinum precursor solution; 200× (FIG. 6B); 500× (FIG. 6C); 1000× (FIG. 6D); 1000× (FIG. 6E); 5000× (FIG. 6F); and 10,000× (FIG. 6G).

FIGS. 7A-7B: Schematic illustrations of non-limiting example devices that the catalyst material can be used in, namely a proton-exchange membrane fuel cell (FIG. 7A) and a catalytic converter (FIG. 7B).

FIGS. 8A-8B: Photographs, after being heated but prior to full conversion (FIG. 8A) and after full conversion (FIG. 8B), of reaction mixtures made with corn syrup (left in each photograph) and reactions mixtures made with dextrose alone as the reducing agent (right in each photograph).

FIGS. 9A-9B: Isotherm linear plot (FIG. 9A) and isotherm tabular report (FIG. 9B) from a first sample of platinum foam.

FIGS. 10A-10B: BET surface area plot (FIG. 10A) of a sample of platinum foam having a BET surface area of 9.5076 m²/g, and BET data from the sample in table form (FIG. 10B).

FIGS. 11A-11B: Isotherm linear plot (FIG. 11A) and isotherm tabular report (FIG. 11B) from a first sample of platinum foam.

FIGS. 12A-12B: BET surface area plot (FIG. 12A) of a sample of platinum foam having a BET surface area of 10.1806 m²/g, and BET data from the sample in table form (FIG. 12B).

FIGS. 13A-13B: SEM image of platinum foam created from reaction with corn syrup as the reducing agent, at 5300× magnification (FIG. 13A), and optical image of the same (FIG. 13B), showing the bright and shiny appearance of the platinum foam.

FIGS. 14A-14B: SEM image of platinum foam created from reaction with a mixture of 20% dextrose 80% cane sugar as the reducing agent, at 4700× magnification (FIG. 14A), and optical image of the same (FIG. 14B), showing the dull grey appearance of the product.

FIGS. 15A-15B: SEM image of platinum foam created from reaction with a mixture of 50% dextrose 50% cane sugar as the reducing agent, at 4700× magnification (FIG. 15A), and optical image of the same (FIG. 15B), showing the dull grey appearance of the product.

FIG. 16: Photograph showing that different metals are easily converted to porous metal.

FIG. 17: Photograph showing how the presently described process is supported by a substrate.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

Described herein is a method for preparing a high surface-area metal catalyst, such as a platinum catalyst, and the catalysts made thereby. The method creates a very porous, high surface area metal that can be used as a catalyst. In general, the metal starts out in a liquid solution containing metal salts such as hexachloroplatinate or a nitrate salt. Then, a reducing agent, such as corn syrup, is added to the solution. Alternatively, the reducing agent is added to a solid metal precursor to create a solution. Optionally, excess liquids are boiled off to produce the desired viscosity.

The resulting solution is then painted, dipped, or infiltrated onto or into a surface or other substrate which is to be coated with a high surface area metal catalyst. The coated and/or infiltrated substrate can be left to dry for a period of time before heating or, alternatively, immediately heated. It is to be understood that in some embodiments, the substrate will have an external coating, while in other embodiments, the substrate can have an at least partial internal coating, or infiltration, of the substrate. As used herein, coating will generally be understood to include the external coating, the internal/infiltrate coating, or both the external and internal/infiltrate coating.

As the substrate is heated, the viscous coating/infiltrate starts to foam, and then decomposes to a metal at a temperature generally between about 200° C. and about 250° C., depending on the makeup of the metal. The resulting metal is a present as a foam with a high surface area. The resulting foamed metal is useful as a catalyst.

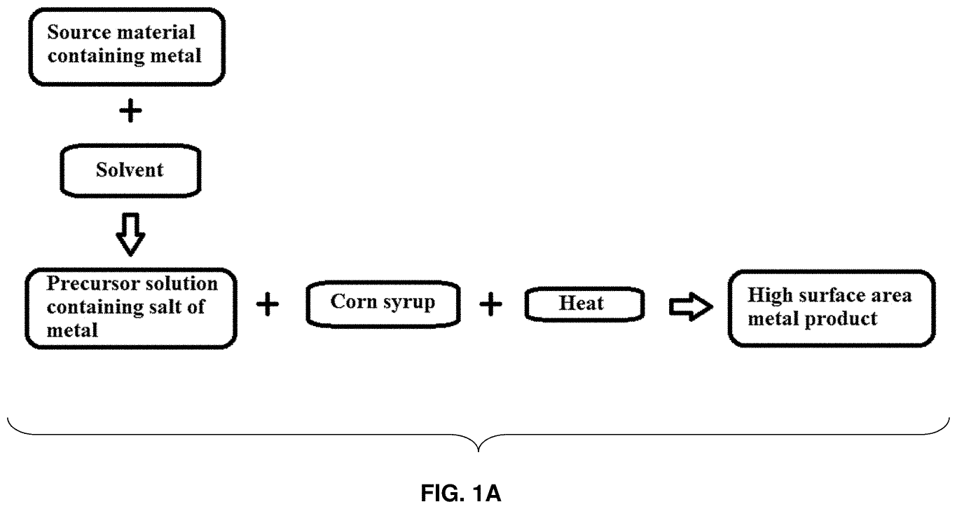

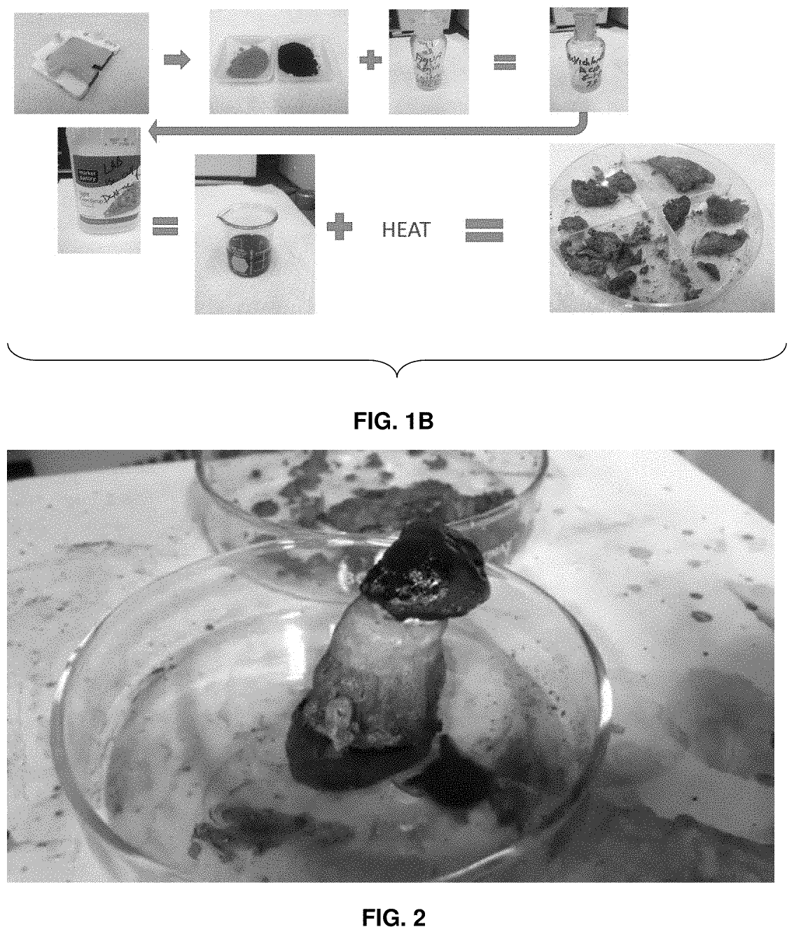

A pictoral flow chart of a non-limiting embodiment of the general method is shown in FIG. 1A, and FIG. 1B shows a flowchart with photographs. As shown in FIG. 1B, the source material can be recycled material containing the metal, such as a mixture of the metal with other compounds. This recycled material can be dissolved in a suitable solvent, such as aqua regia, to create a precursor solution that contains a salt of the metal. For example, the metal may be platinum, and the solution may contain hexachloroplatinate. Though aqua regia is mentioned for exemplary purposes, a wide variety of combinations or other solvents can be used to tailor the process to the desired outcome. The reducing agent is added to the precursor solution, and the resulting reaction mixture is applied to a substrate and then heated to produce a metal foam, such as platinum foam. Alternatively, the reducing agent is added directly to a solid metal precursor, such as dihydrogen hexachloroplatinate hexahydrate, to form a reaction mixture which is applied to a substrate and then foams upon heating to produce a high surface area metal catalyst.

FIG. 2 is a photograph showing an example of the foaming reaction mixture prior to auto ignition.

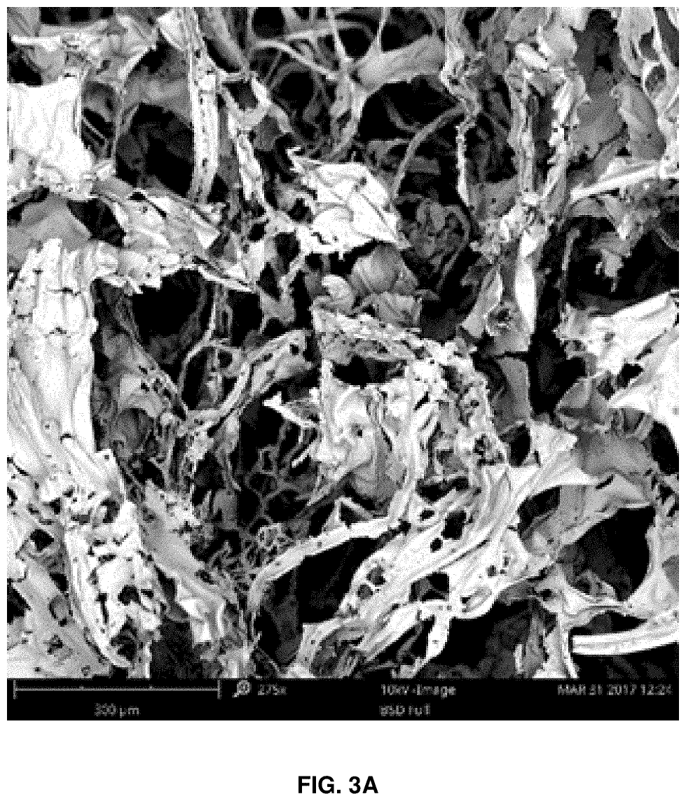

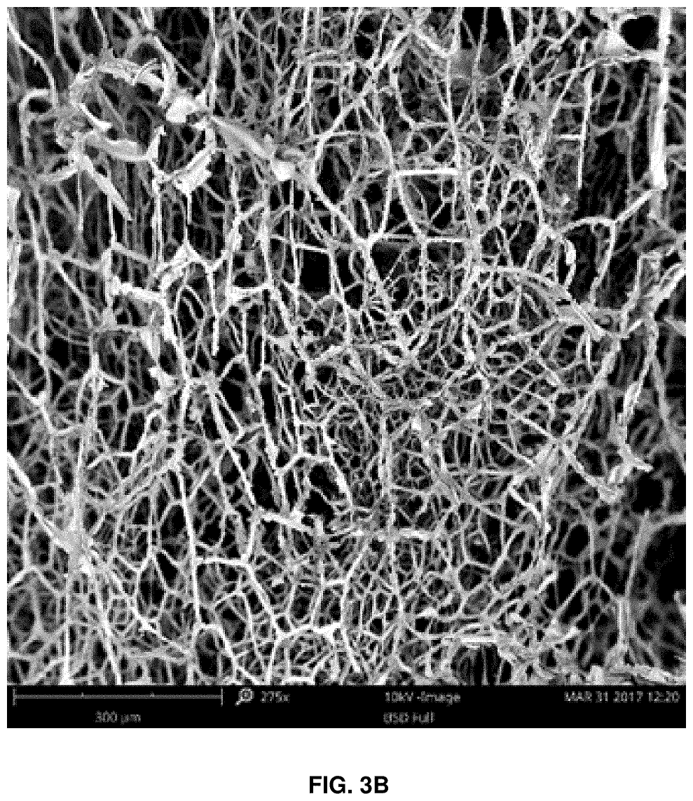

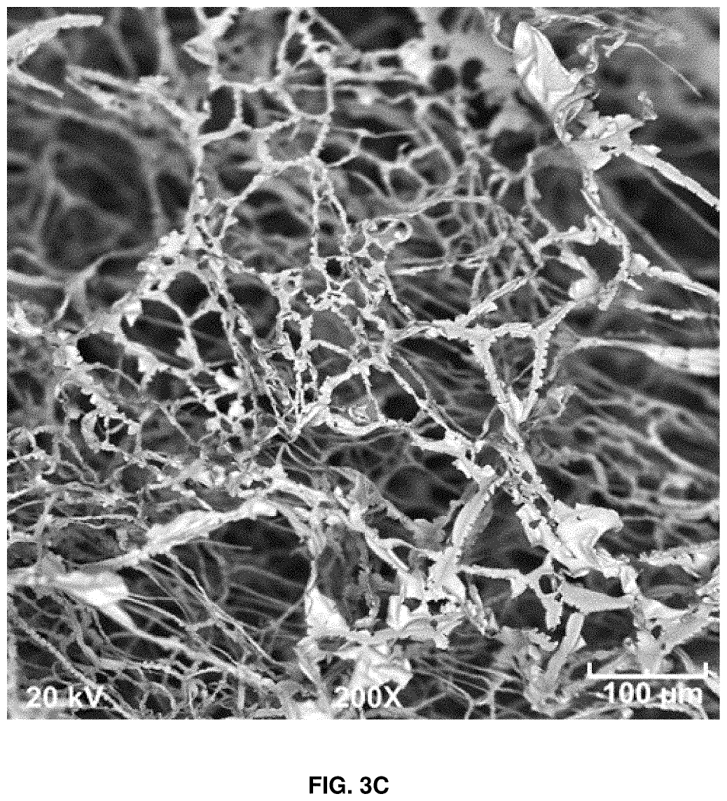

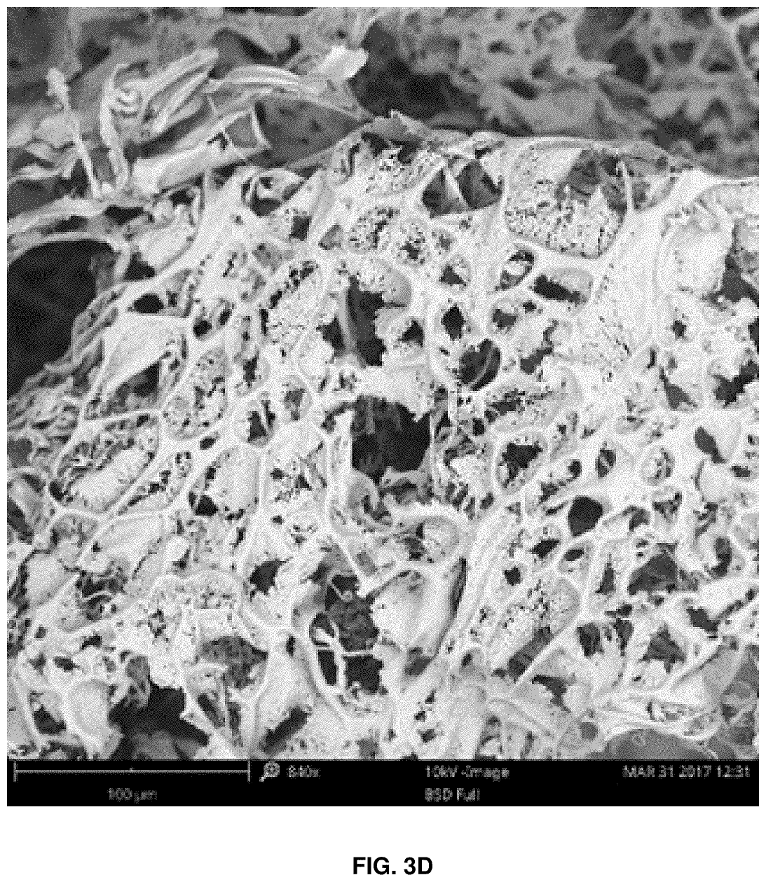

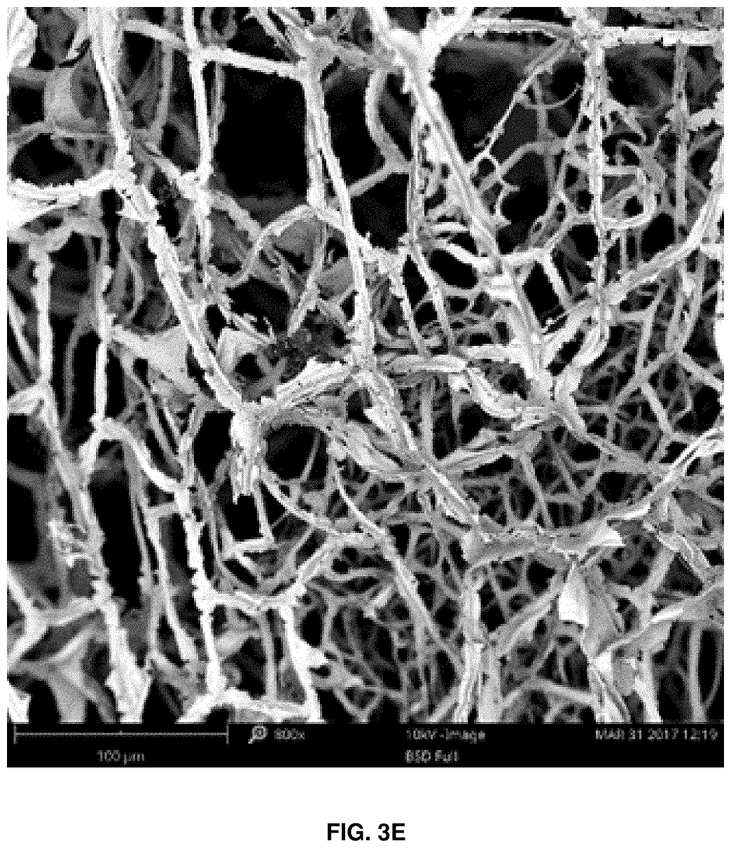

FIGS. 3A-3E are SEM images of platinum foam created by the method, at varying levels of magnification, illustrating the high surface area of the metal product.

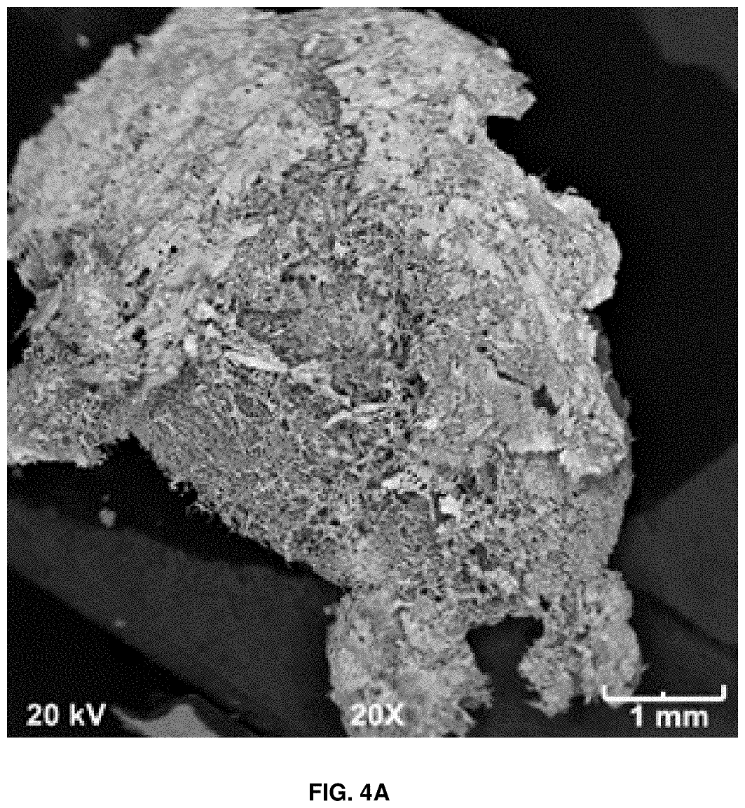

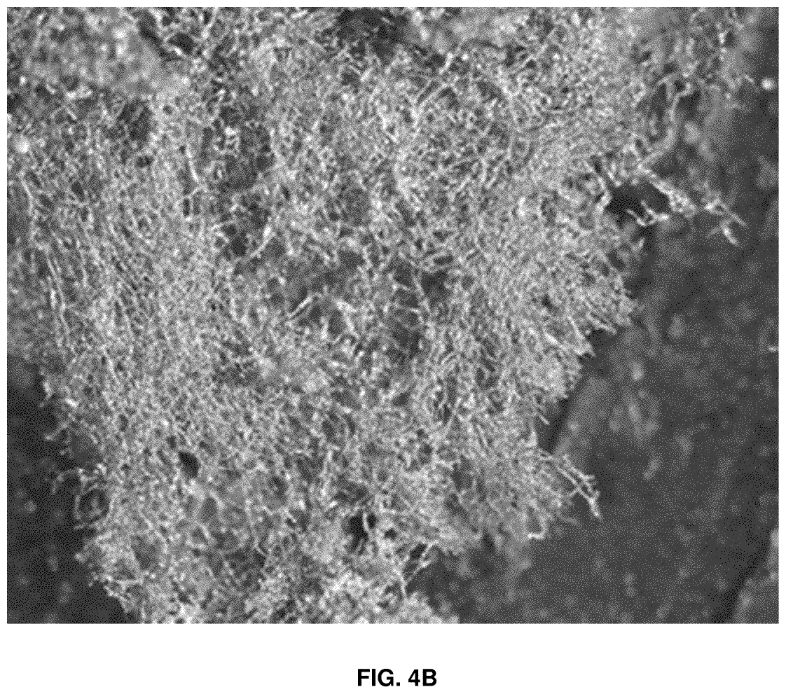

FIGS. 4A-4B show photographs of the platinum foam at 20× (FIG. 4A) and no (FIG. 4B) magnification, clearly showing the porous structure of the foam.

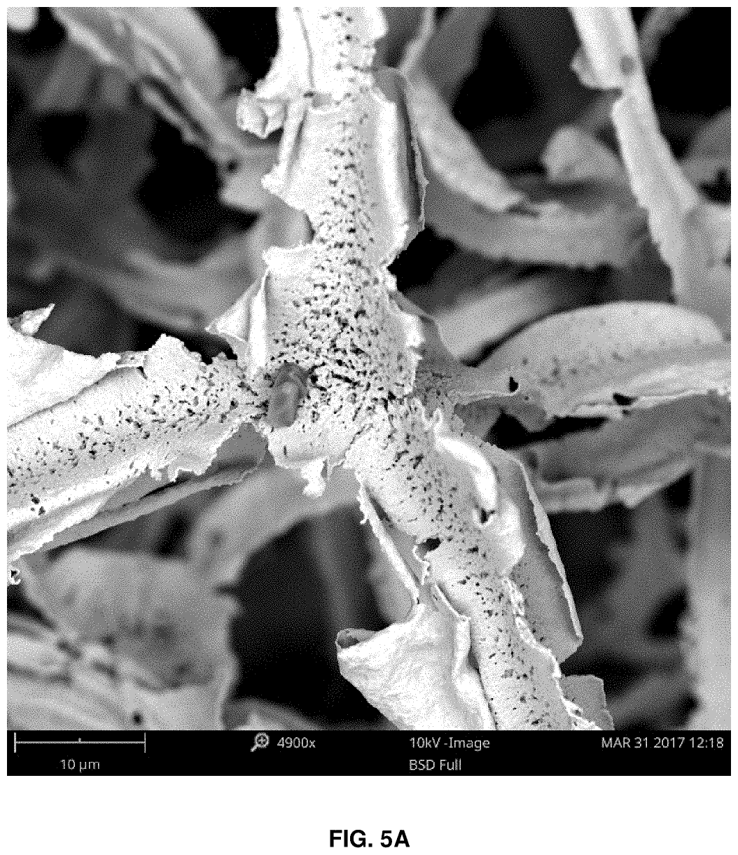

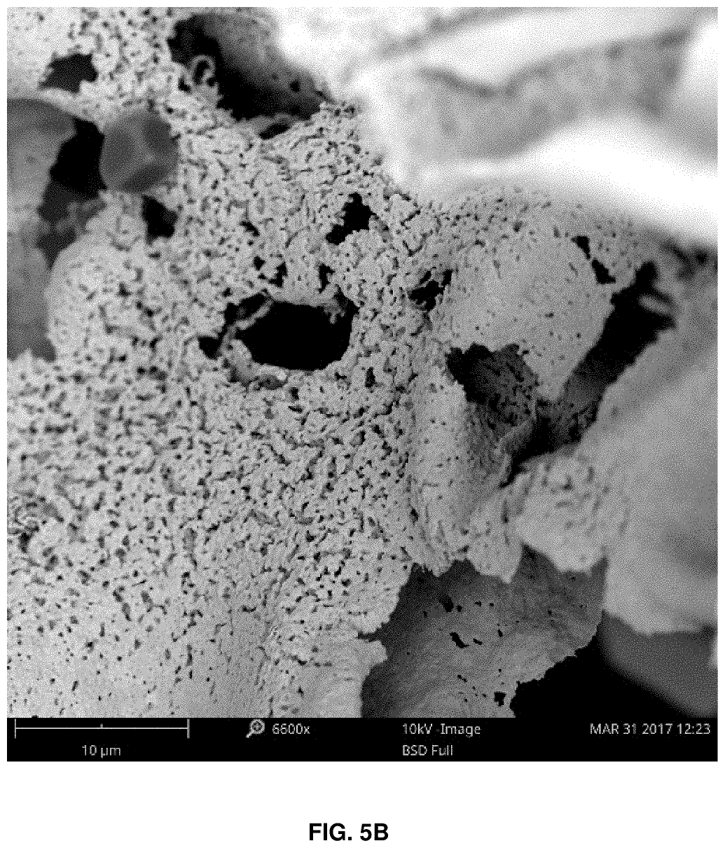

FIGS. 5A-5B are SEM images at higher magnification (namely, 4900× and 6600× magnification), showing the porous nanostructure of the platinum foam. As clearly seen in these images, the method can be used to make very high surface area metal products.

As noted, in some embodiments, the reducing agent is corn syrup. Corn syrup generally contains varying amounts of maltose and higher oligosaccharides. Corn syrup can be made by, for instance, boiling cornstarch, or may be purchased commercially. Most commercial corn syrups have about ⅓ glucose by weight. A non-limiting corn syrup may contain from about 20% to about 98% glucose. Commercially available corn syrups may also contain additional additives such as flavorings. For example, light corn syrup is generally seasoned with vanilla flavor and salt. Dark corn syrup is generally a combination of corn syrup and molasses (or Refiner's syrup), caramel color and flavor, salt, and the preservative sodium benzoate. As described in the examples herein, both commercially available light corn syrup and commercially available dark corn syrup work well to prepare a high surface area catalyst as described herein. Thus, the particular type/brand of corn syrup reducing agent used is not especially limited. For clarity, the term “corn syrup” as used herein refers to any form of syrup containing a significant amount of dissolved sugars, provided that the dissolved sugars include more sugars than only dextrose. Dextrose is one of the two stereoisomers of glucose, also known as D-glucose.

The sugars in corn syrup cause the reaction mixture containing a metal salt to foam until the auto ignition temperature is reached. Surprisingly, it has been found that, while corn syrup creates a foaming effect to produce the high surface area metal catalyst, dextrose alone does not. As seen in the examples herein, when the method is attempted with dextrose alone as the reducing agent instead of corn syrup, dextrose alone does not result in a high surface area platinum catalyst, but, rather, results in a smear on the substrate that decomposes instead of foams upon heating. Thus, while the method can be practiced with any corn syrup as the reducing agent, the method cannot be practiced using dextrose alone as the reducing agent to still produce a high surface area catalyst.

In other embodiments, when the method is attempted with cane sugar as the reducing agent, the reaction requires a higher temperature to ignite (>300° C.), and the product is not pure metal. Rather, in one example, the use of cane sugar as a reducing a agent with a platinum precursor results in a product that including platinum oxide, platinum chloride, and carbon. However, the reaction does still foam to create a high surface area product. Thus, the use of cane sugar alone as the reducing agent is not optimal, but nonetheless also creates a high surface area catalyst.

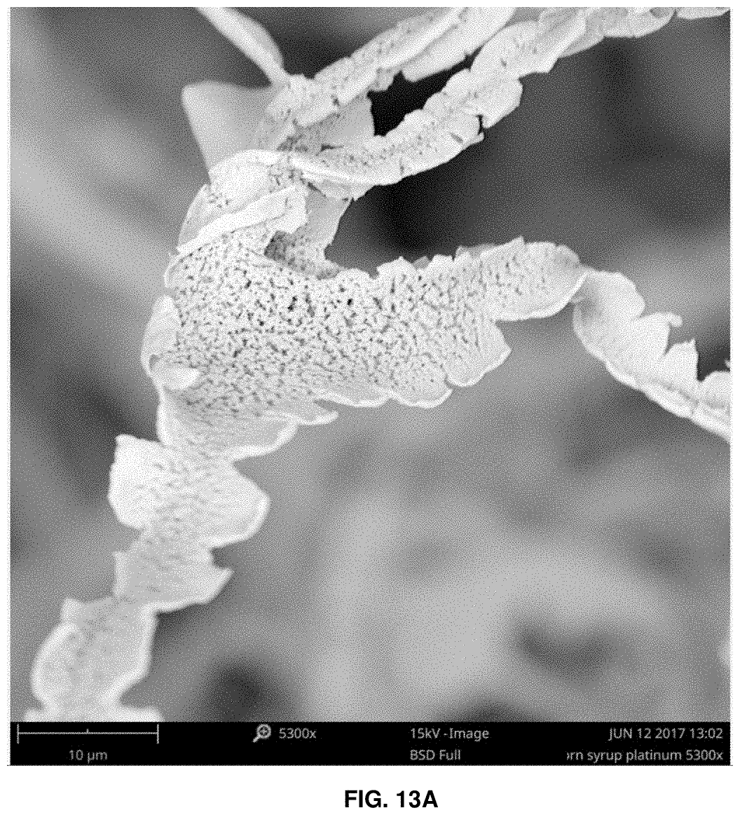

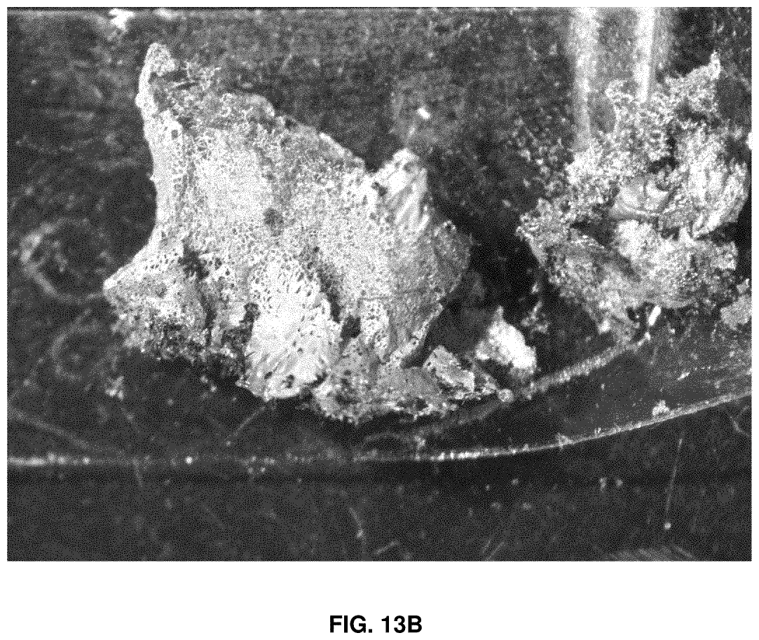

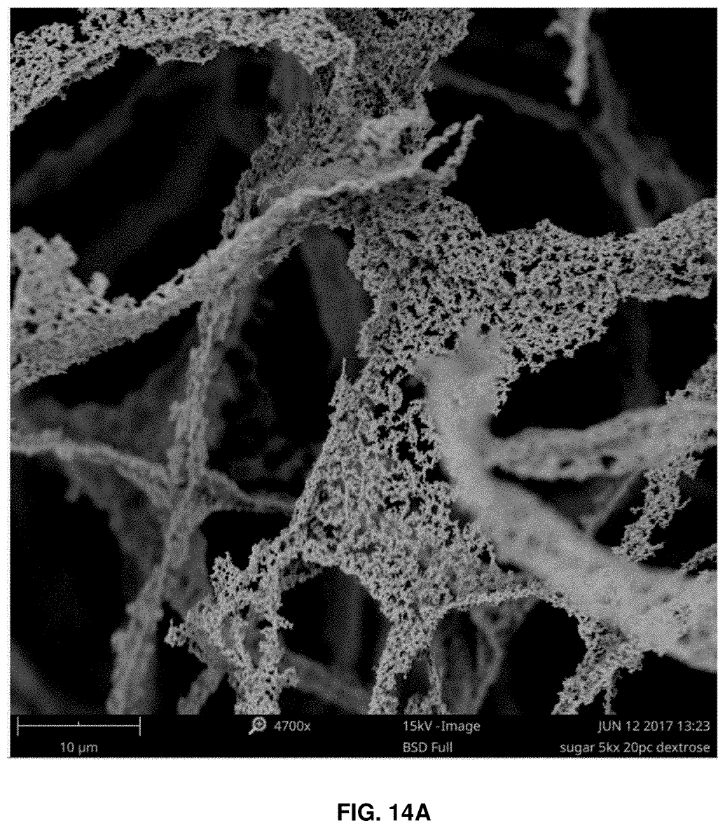

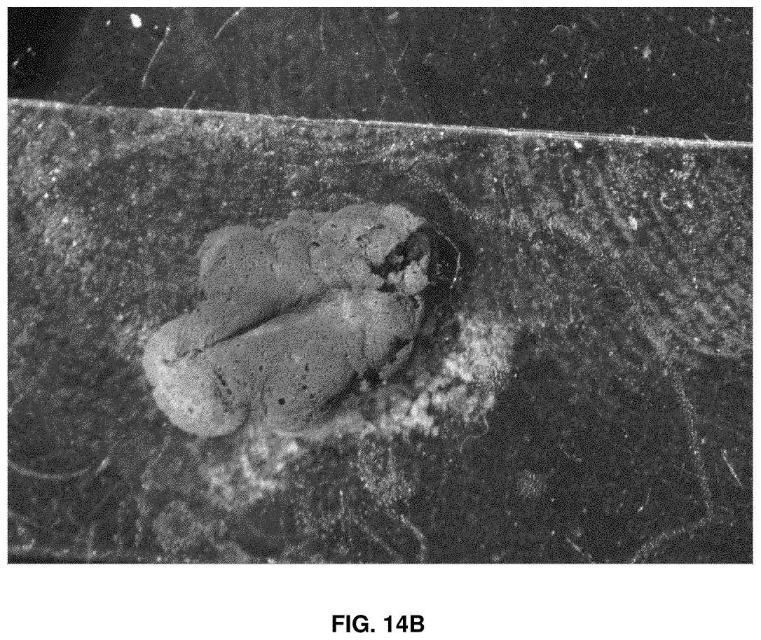

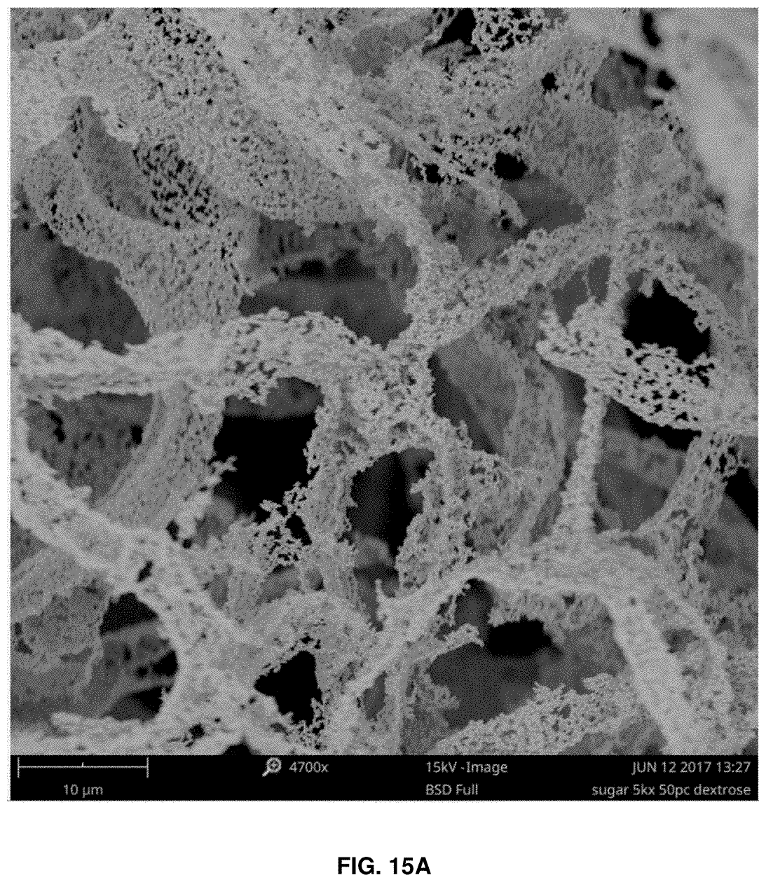

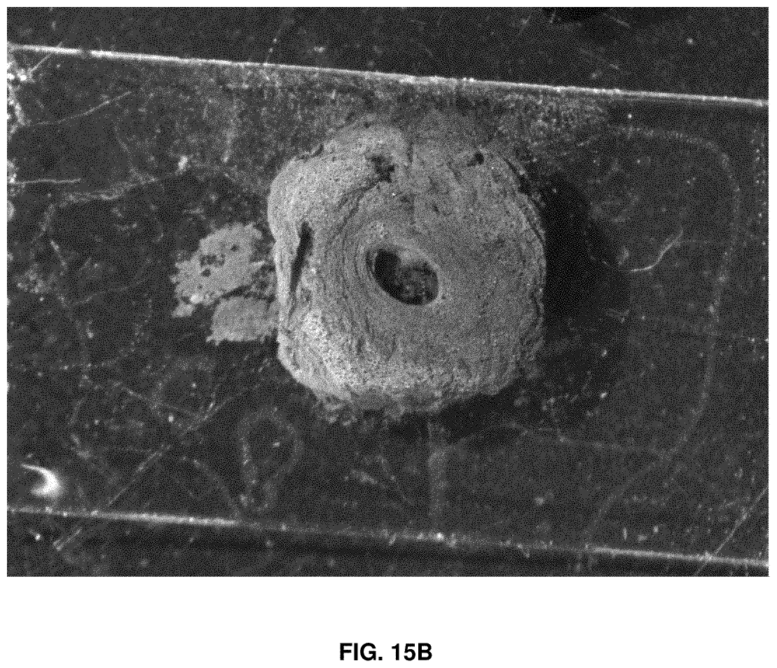

In some embodiments, a mixture of cane sugar and dextrose is used as the reducing agent. As demonstrated in the examples herein, a mixture of cane sugar and dextrose still produces a high surface area product, albeit at a higher temperature for the reaction to ignite. For example, a mixture of dextrose and cane sugar used as the reducing agent with a platinum precursor produces a reaction that starts around 300° C., and results in a high surface area platinum product with substantially no oxides or chlorides present. Some carbon may be present in the product, but not at the same level produced when pure cane sugar is used as the reducing agent. Furthermore, a mixture of cane sugar and dextrose produces a dull grey platinum product (FIGS. 14-15), as opposed to the bright and shiny platinum product produced by a corn syrup reducing agent (FIGS. 13A-13B). While not wishing to be bound by theory, it is believed that this is due to the residual carbon as well as a different microstructure. In particular, the dextrose/cane sugar platinum product shows severe porosity in the veins compared to the corn syrup product, which affects light reflection. Thus, while mixtures of two or more sugars, such as mixtures of cane sugar and dextrose, may produce useful catalyst products, the products are nonetheless distinct from the high surface area metal catalysts produced from the use of corn syrup as the reducing agent. Furthermore, any amount of sugar additive may be mixed with a corn syrup reducing agent.

The reaction mixture (also referred to herein as the precursor solution) can be applied in a single step of painting, spraying, dipping, etc., the liquid solution into/onto the substrate. The method of application of the precursor solution to the substrate is not limited. Once applied to the substrate, the viscosity of the precursor solution can be adjusted to accommodate the desired process environment. However, the viscosity does not need to be adjusted in order to create a high surface area catalyst. In general, as the viscosity is reduced, the surface area of the metal product is increased. Furthermore, the ratio (by weight) of metal salt-to-corn syrup can be adjusted to tailor the pore and grain size. In general, as the weight ratio of metal salt-to-corn syrup decreases, the pore size increases. Without wishing to be bound by theory, it is believed that this increases surface area of the metal product. The viscosity and the weight ratio of metal salt to corn syrup are two variables which can be adjusted in order to control the surface area of the resulting metal product. In any event, without wishing to be bound by theory, it is believed that the water or methanol (if present) evaporates off before combustion, causing the reaction mixter to become more viscous before converting to the high surface area product.

The coating (i.e., the reaction mixture applied to the substrate) is typically dried in air at approximately 80° C. for 2 hours, but this drying step is also not strictly necessary and may be omitted. Then, the coated substrate is heated to a temperature as low as about 200° C., or about 250° C., for a time period of about 15 minutes or more. The exact temperature is dependent on the identity of the metal precursor. In general, heating to about 200° C. or about 250° C. results in a metal foam that has a very high surface area. The size of the structure can be altered depending on the process. Advantageously, this method creates a metal foam in one step from a liquid to metal, whereas other processes need a reduction process to create metal from a liquid or solid precursor.

In other embodiments, the method is utilized with metals which oxidize or have oxidized surfaces, and the method may further include an additional reduction step in order to reduce oxides to metals. For example, for metals that oxidize, or metals that may have an oxidized surface such as Ni or Cu, the high surface area metal foam can be subjected to a separate reduction process whereby the high surface area metal foam is heated in an atmosphere such as 5% hydrogen 95% nitrogen (forming gas) to reduce any oxide to metal. Heating in a reducing atmosphere, such as a hydrogen/inert gas mix, is also possible to rejuvenate such a high surface area catalyst.

As mentioned, the method creates an open porosity high surface area metal foam. Moreover, though platinum is described for exemplary purposes, the metal can be other metals such as, but not limited to, palladium, silver, gold, nickel, copper, or oxides, alloys, or mixtures thereof. For example, corn syrup can be added to a solution containing salts of gold, silver, and nickel. The precursor solution can then be coated onto a substrate and heated to about 250° C. for a period of time at which point the precursor solution decomposes to reduced metals. Optionally, the product can be allowed to cool, but such cooling is not necessary.

As another example, the method can be used to produce a high surface area catalyst from an intimate mixture of metal(s) and oxides. As one non-limiting example, the high surface area catalyst can include a mixture of one or more metals selected from platinum, palladium, nickel, or silver and one or more oxides selected from cerium oxide, gadolinium oxide, or yttria stabilized zirconia (YSZ). For example, the metal catalyst may be a Ni-doped YSZ. In certain embodiments, the metal catalyst comprises a cermet, which is a heat-resistant material made of ceramics and sintered metal. In such embodiments, the reaction mixture may include one or more soluble oxides in addition to the metal salt. Alternatively, the reaction mixture may include multiple metals and be subjected to an oxidation step before or after heating to produce one or more metal oxides. A wide variety of mixed ionic electronic conductors having a high surface area may be produced in accordance with the method described herein.

The substrate used in the method described herein can be any suitable material on or in which a high surface area catalyst is desired. Non-limiting example substrate materials are metals, alloys, plastics, or ceramics. The identity of the substrate may depend on the desired application for the product. For example, if the metal catalyst is to be used in a catalytic converter, then the substrate may be a ceramic monolith with a honeycomb structure. The composition of the substrate is not particularly limited.

The metal catalysts created by the method can have very high surface areas. For example, the platinum catalysts created by the method can have a surface area of at least about 8 m²/g. In some embodiments, the platinum catalysts have a surface area of at least about 10 m²/g. Typically, a surface area above 5 m²/g results in desirable catalytic activity. Thus, the method advantageously provides a simple approach for producing metal products with desirable catalytic activity.

There are numerous advantages to the method described herein. For example, the method is a simple, one-step process. It uses a low temperatures to decompose the constituents to metal, and produces a very high surface area catalyst. The viscosity is easily adjustable by boiling the excess liquids. The catalyst can be formed within the pores of a porous substrate. The method can easily be tailored to change pore size and viscosity for specific applications. The method produces an easy-to-apply, high surface area catalyst useable in a wide variety of applications. For example, the catalyst described herein can be used as an anode/cathode in a battery/fuel cell/electrolyzer, or in a wide variety of batteries, membranes, sensors, electrodes, fuel cells, filters, or the like.

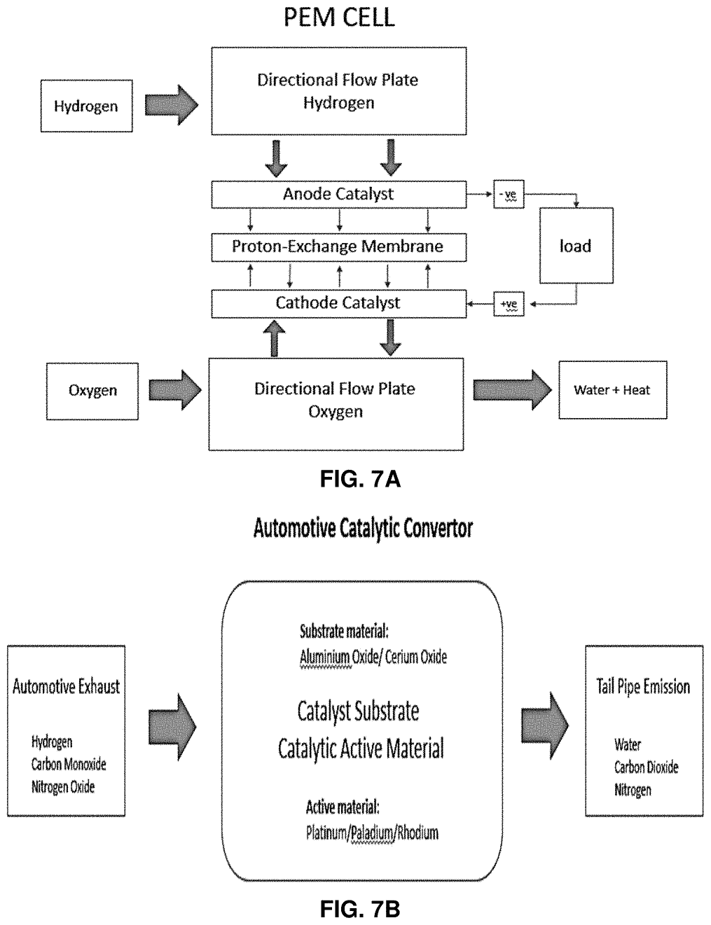

For example, the catalyst can be prepared to infiltrate a solid oxide fuel cell (SOFC) or a solid oxide electrolyzer cell (SOEC). A SOEC is a fuel cell which basically runs similar to a SOFC in reverse, running in regenerative mode to achieve electrolysis of water using a solid oxide, ceramic, or electrolyte to produce hydrogen gas and oxygen. Additional non-limiting example uses of the catalysts include to produce methane, to reduce pollutants from automobiles, to oxidize CO, or to hydrogenate unsaturated compounds. FIGS. 7A-7B illustrate two non-limiting example devices that the catalyst material can be used in, namely a proton-exchange membrane fuel cell and a catalytic converter.

A proton-exchange membrane fuel cell, depicted in FIG. 7A, also known as a polymer electrolyte membrane fuel cell (PEMFC), is a type of fuel cell in which lower temperature/pressure ranges (e.g., 50 to 100° C.) and a proton-conducting polymer electrolyte membrane are utilized. PEMFCs generate electricity in a manner opposite to PEM electrolysis, which is the electrolysis of water in a cell equipped with a solid polymer electrolyte which conducts protons, separates product gases, and electrically insulates the electrodes. PEMFCs typically include membrane electrode assemblies which are composed of the electrodes, electrolyte, catalyst, and gas diffusion layers. Thus, PEMFCs transform the chemical energy liberated during the electrochemical reaction of hydrogen and oxygen to electrical energy. Hydrogen is delivered to an anode side of the membrane electrode assembly, where it is catalytically split into protons and electrons. The protons permeate through the polymer electrolyte membrane to the cathode side, while the electrons travel along an external load circuit to the cathode side, thereby creating the current output of the PEMFC. Oxygen is delivered to the cathode side, where the oxygen molecules react with the protons permeating through the polymer electrolyte membrane and the electrons arriving through the external circuit to form water molecules. The catalyst for such a fuel cell is generally sprayed or painted onto the solid electrolyte. Thus, in some embodiments of the method described herein, the substrate is a solid electrolyte.

A catalytic converter, depicted in FIG. 7B, converts byproducts of combustion to less toxic substances by performing catalyzed chemical reactions. In particular, a catalytic converter catalyzes a redox reaction, for instance to convert carbon dioxide into water vapor. In a typical catalytic converter, the catalyst-coated substrate is a catalytic core providing a high surface area. A catalyst washcoat acts as a carrier for the catalytic substrate that disperses the materials over the high surface area. The catalytic materials are suspended in the washcoat prior to applying to the core. In some embodiments, the core is a ceramic monolith with a honeycomb structure. The platinum catalyst acts as a reduction catalyst and as an oxidation catalyst. Thus, in some embodiments of the method described herein, the substrate is a ceramic monolith with a honeycomb structure.

The compositions and methods described herein can be embodied as parts of a kit or kits. A non-limiting example of such a kit is a kit for making a catalyst, the kit comprising corn syrup and a source of metal in separate containers, where the containers may or may not be present in a combined configuration. Many other kits are possible, such as kits comprising a metal precursor solution, or kits further comprising a substrate. The kits may further include instructions for using the components of the kit to practice the subject methods. The instructions for practicing the subject methods are generally recorded on a suitable recording medium. For example, the instructions may be present in the kits as a package insert or in the labeling of the container of the kit or components thereof. In other embodiments, the instructions are present as an electronic storage data file present on a suitable computer readable storage medium, such as a flash drive. In other embodiments, the actual instructions are not present in the kit, but means for obtaining the instructions from a remote source, such as via the internet, are provided. An example of this embodiment is a kit that includes a web address where the instructions can be viewed and/or from which the instructions can be downloaded. As with the instructions, this means for obtaining the instructions is recorded on a suitable substrate.

### EXAMPLES

Production of High Surface Area Platinum Catalysts

Platinum powder (1.5 g) was dissolved in aqua regia (3 parts hydrochloric acid:1 part nitric acid) to create a solution containing H₂PtCl₆. Dihydrogen hexachloroplatinate hexahydrate (dried granule H₂PtCl₆.6H₂O) was purchased from Alpha Aesar (stock number 11051). As explained, the method was conducted using the solution containing H₂PtCl₆ and separately using the dried dihydrogen hexachloroplatinate hexahydrate, each producing good results. Two different kinds of corn syrup were tried: Karo dark corn syrup and Market Pantry® light corn syrup (Target brand). Each type of corn syrup worked equally well in the process.

Four different recipes were used to make the precursor solution, each resulting in a different viscosity.

Recipe 1 used dried dihydrogen hexachloroplatinate hexahydrate (dried granule H₂PtCl₆.6H₂O) purchased from Alpha Aesar (stock number 11051) without water. 5 gm corn syrup was added to 3 gm Alpha #11051. The solution was heated on a hotplate to remove excess water until it foamed. The product was allowed to cool. The result was a high surface area platinum foam.

Recipe 2 used hexochloroplatinic acid in liquid form. 5 gm liquid platinic acid was added to 5 gm corn syrup. The solution was heated on a hotplate to remove excess water until it foamed. The product was allowed to cool. The result was a high surface area platinum foam.

Recipe 3 used dried dihydrogen hexachloroplatinate hexahydrate (Alpha #11051). 5 gm Alpha #11051 was added to 5 mL water and 6 g corn syrup. The solution was heated on a hotplate to remove excess water until it foamed. The product was allowed to cool. The result was a high surface area platinum foam.

Of the above three recipes, recipe 1 resulted in the highest viscosity solution and the largest pore size. FIGS. 3A-3E show SEM images of platinum foam created by recipces 1-3, at varying levels of magnification, illustrating the high surface area. FIGS. 4A-4B show photographs of the platinum foam at 20× (FIG. 4A) and no (FIG. 4B) magnification, clearly showing the porous structure of the foam. FIGS. 5A-5B show SEM images at higher magnification (namely, 4900× and 6600× magnification), showing the porous nanostructure of the platinum foam.

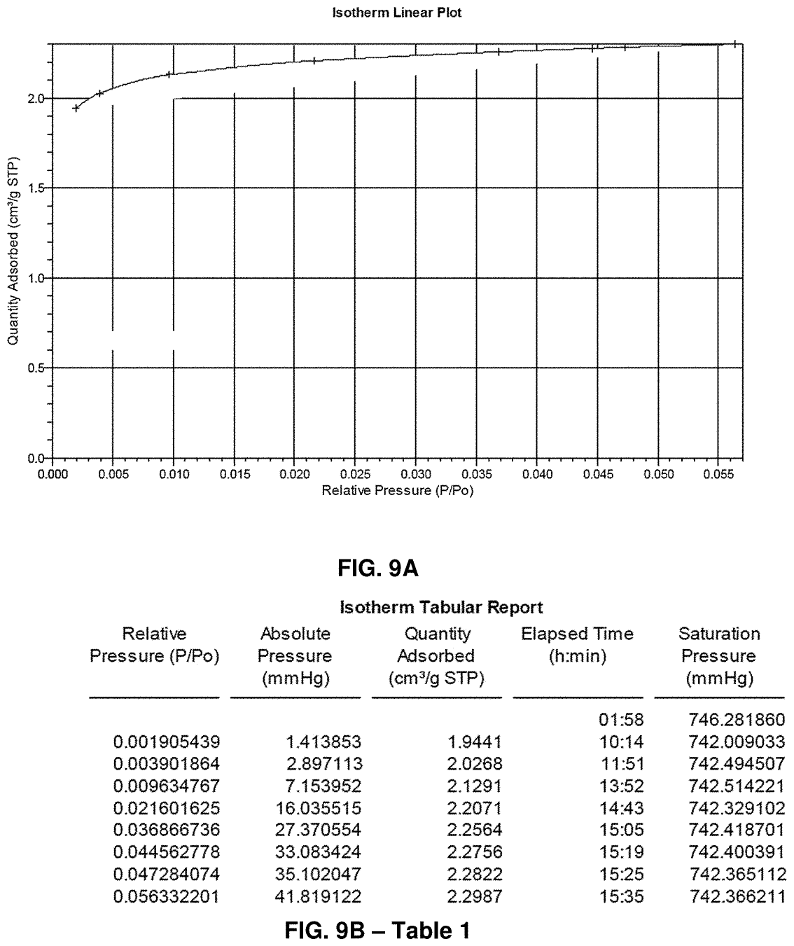

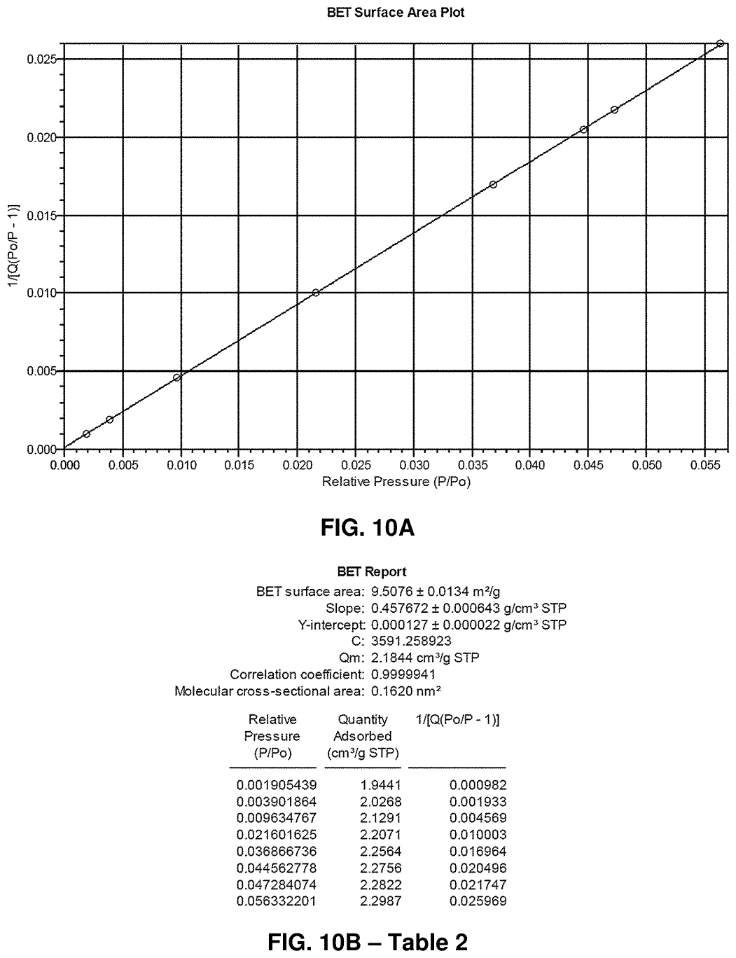

Two samples of platinum foam made from the above recipes were characterized for surface area. The first sample had a BET surface area of 9.5076 m²/g, and an average particle size of about 631 nm. The single point surface area at P/P₀ was 9.4416 m²/g. The micropore surface area was measured to be 10.3112 m²/g. The cumulative surface area of pores was measured to be between 2.2539 angstroms and 3.400 angstroms with a hydraulic radius of 11.9561 m²/g. FIG. 9A shows an isotherm linear plot from the first sample, and FIG. 9B shows Table 1, depicting the isotherm results in table form. FIG. 10A shows the BET surface area plot from the first sample, and FIG. 10B shows Table 2, depicting the BET data in table form.

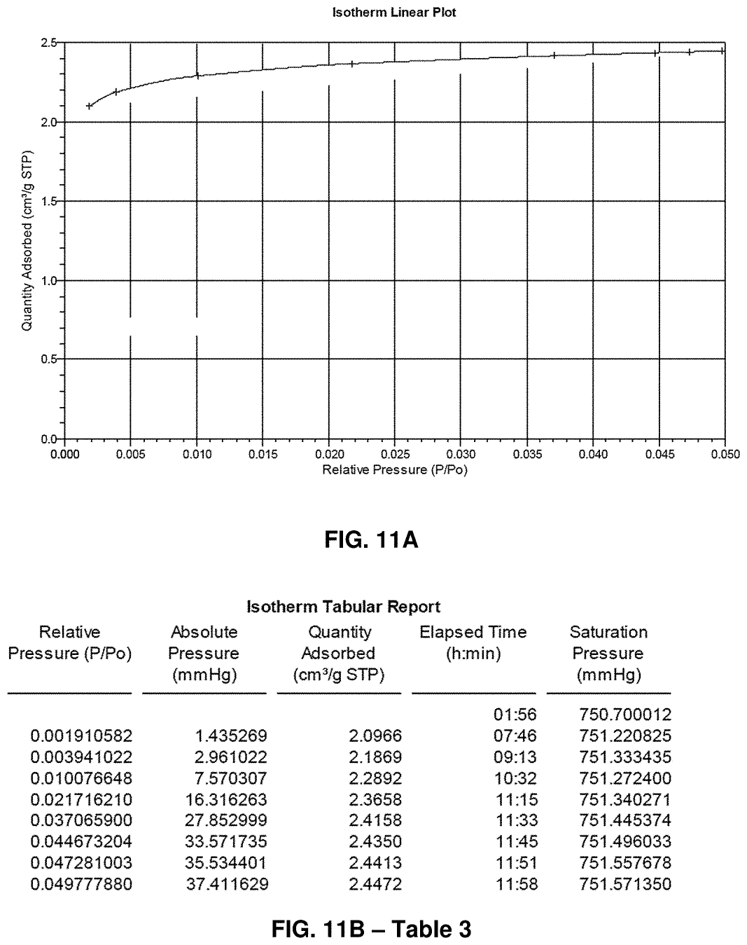

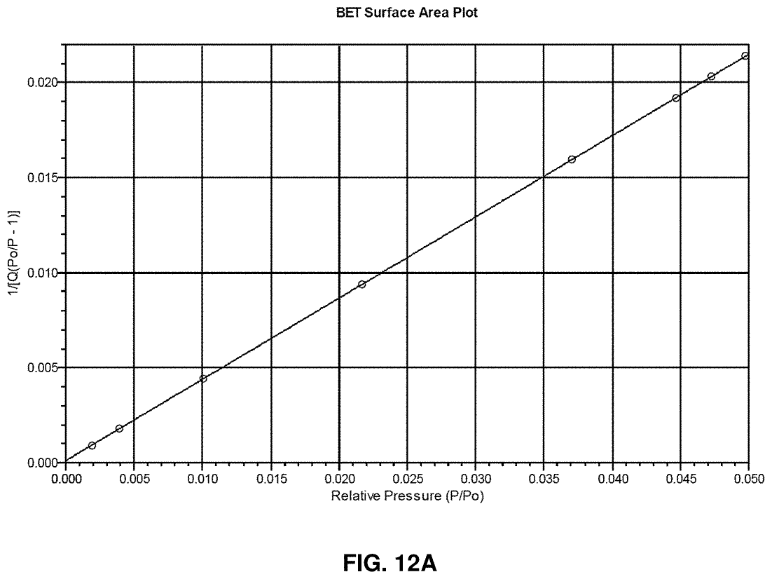

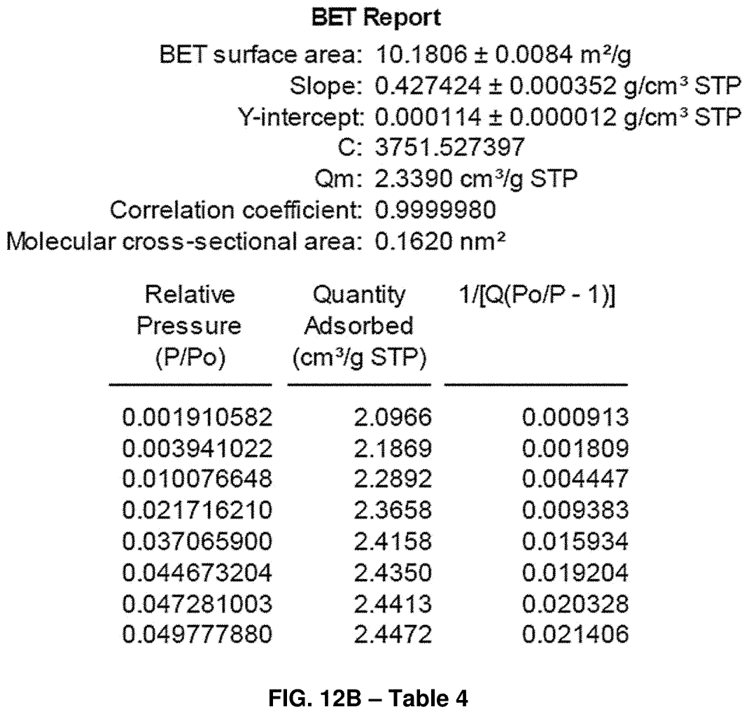

The second sample had a BET surface area of 10.1806 m²/g, and an average particle size of about 589 nm. The single point surface area at P/P₀ was 10.1214 m²/g. The micropore surface area was measure to be 11.1237 m²/g. The cumulative surface area of pores was measured to be between 2.2543 angstroms and 3.2000 angstroms with a hydraulic radius of 10.9949 m²/g. FIG. 11A shows an isotherm linear plot from the second sample, and FIG. 11B shows Table 3, depicting the isotherm results in table form. FIG. 12A shows the BET surface area plot from the second sample, and FIG. 12B shows Table 4, depicting the BET data in table form.

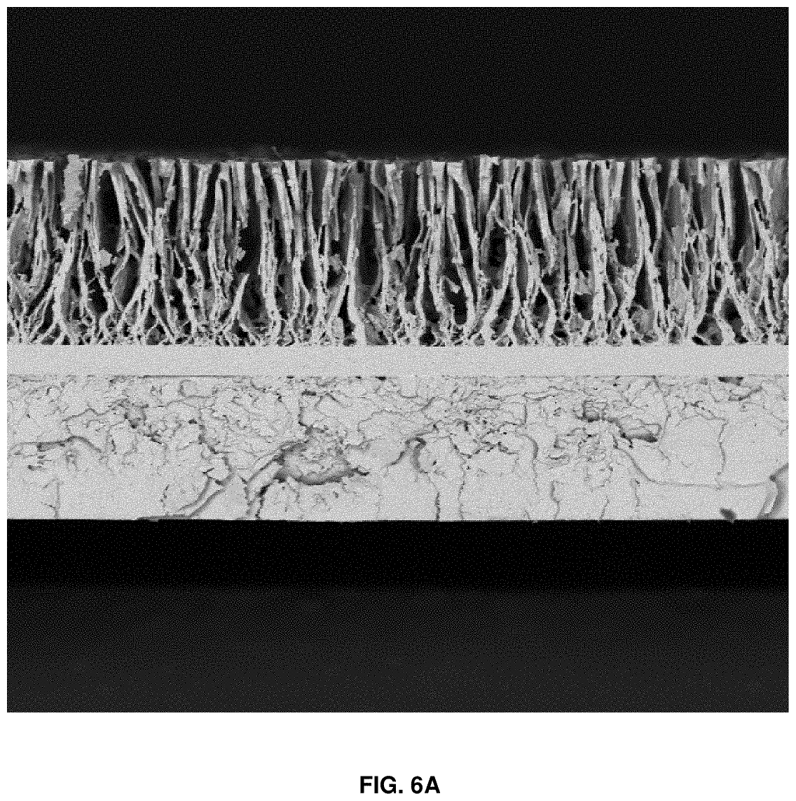

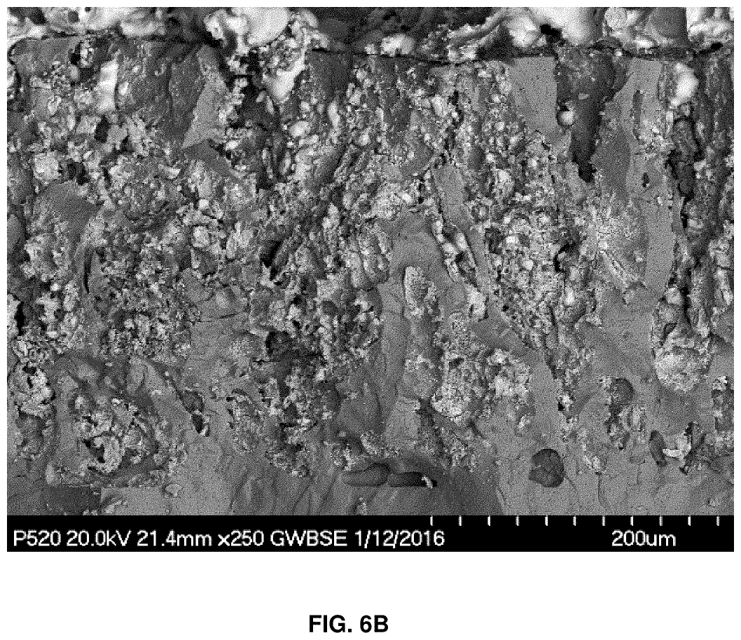

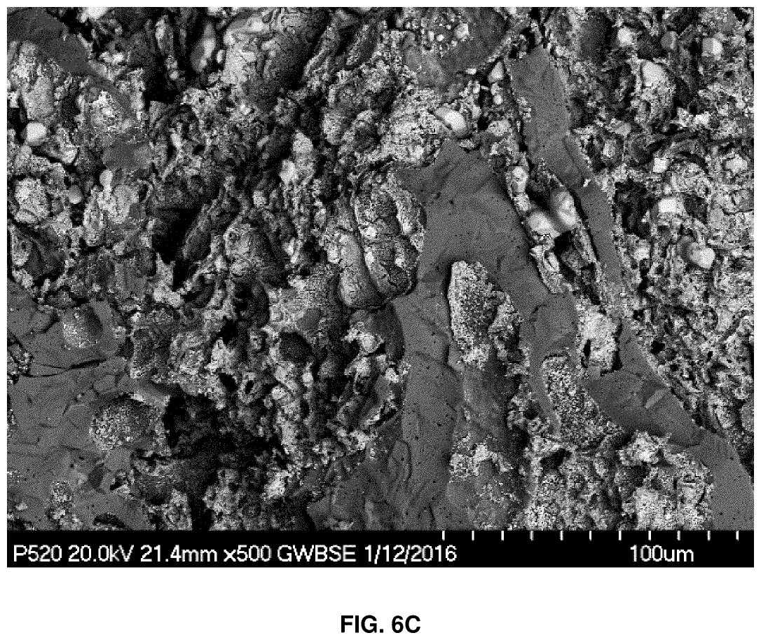

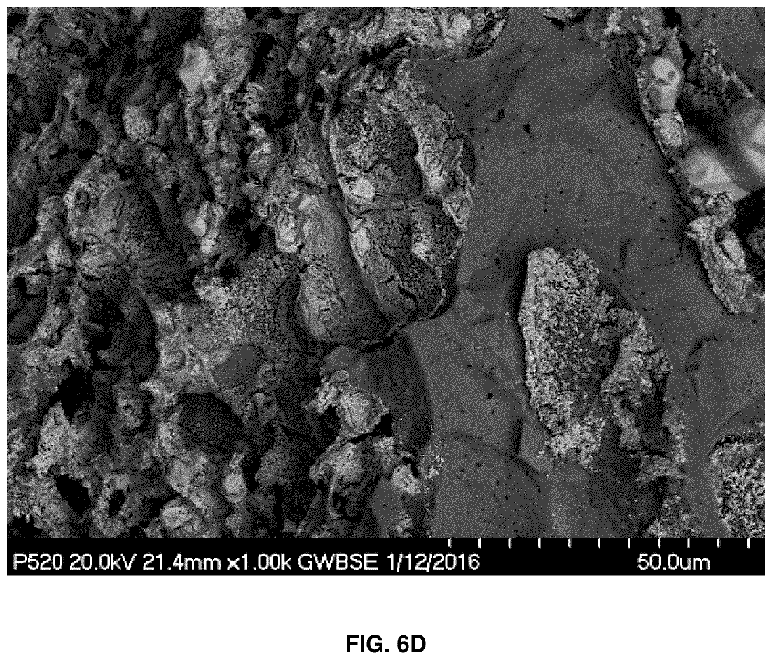

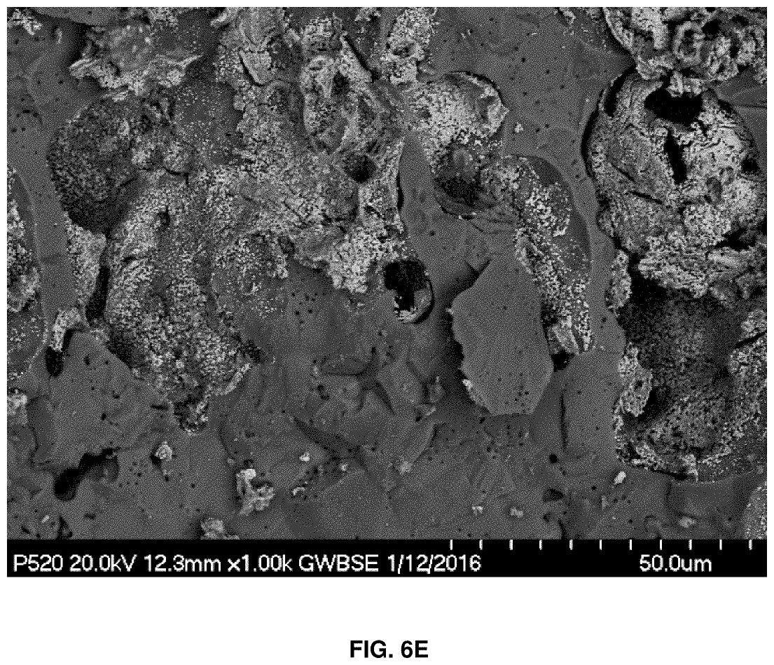

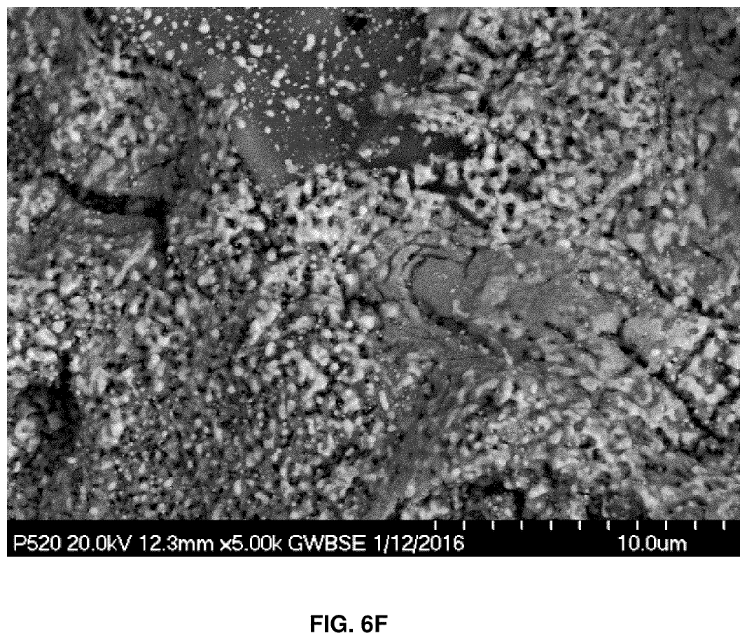

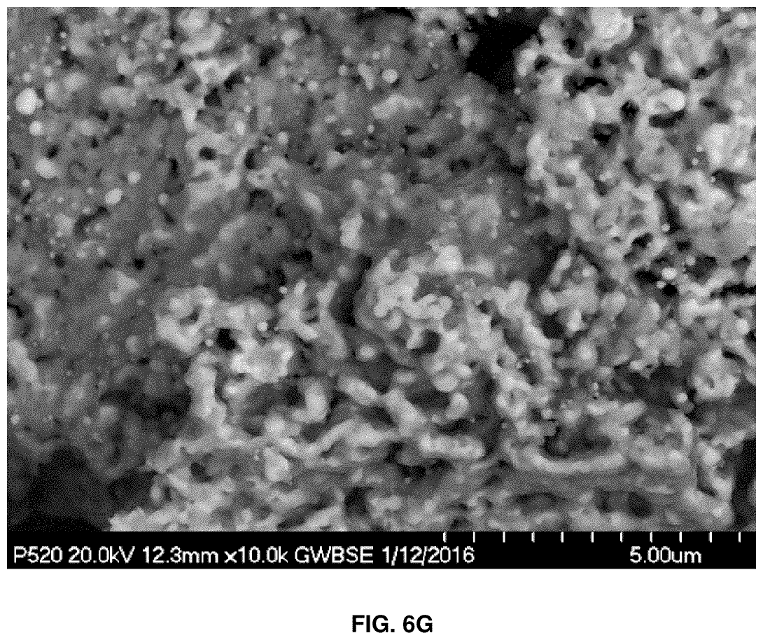

Recipe 4 was made to thin down (i.e., reduce the viscosity of) the reaction mixture further in order to infiltrate the reaction mixture into a porous body. 0.75 g platinum precursor from the above processes was added to 0.75 g methanol to produce a platinum-containing precursor solution. FIGS. 6A-6G show SEM images of a freezecast structure infiltrated with the platinum-containing precursor solution. As seen in these images, the precursor solution infiltrated the substrate. The infiltrated substrate was heated to produce a high surface area platinum catalyst in the pores of the substrate.

Comparison with Dextrose Alone

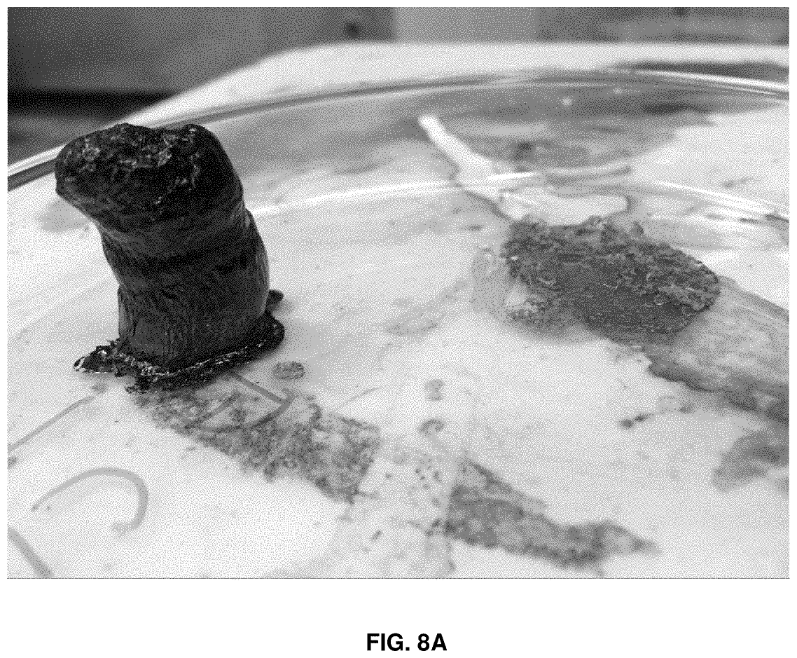

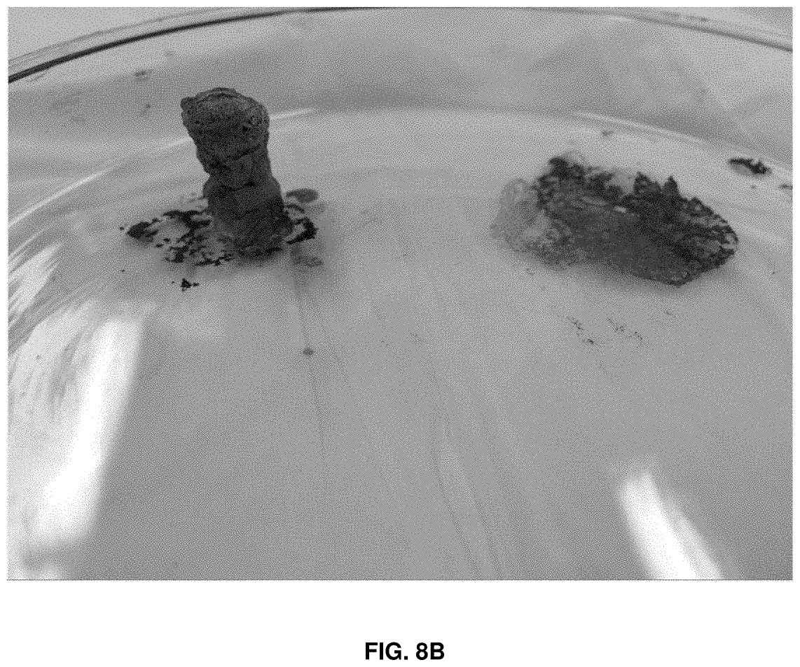

Recipe 2 from above was used for a comparison with dextrose alone instead of corn syrup as the reducing agent. For the dextrose alone sample, the corn syrup was replaced with an equal amount of dextrose. FIG. 8A shows a photograph of the reaction mixtures after being heated but prior to full conversion, where the reaction mixture made with corn syrup is on the left in the photograph and the reaction mixture made with dextrose is on the right in the photograph. The photograph in FIG. 8A shows a black ‘tower’ which is the corn syrup platinum that has been heated, but has not completely converted to platinum metal. The smear that is next to the black ‘tower’ is the dextrose sample, but it has already decomposed from being heated. FIG. 8B shows the same two reaction mixtures following full conversion, again with the corn syrup mixture on the left and the dextrose mixture on the right. The photograph in FIG. 8B shows the grey ‘tower’ after full conversion, and a smear representing what remained of the dextrose sample after full conversion. Because the dextrose sample peeled up from the glass surface during heating, it lifted during decomposition of the dextrose, and there was not sufficient material to further characterize the dextrose product. This comparison clearly shows that dextrose by itself does not cause the same foaming action, which creates a high surface area product, caused by corn syrup. Thus, dextrose alone as the reducing agent does not produce the same result as corn syrup.

Comparison with Cane Sugar

Cane sugar alone was used as the reducing agent instead of corn syrup. Although the platinum did foam, it ignited at a much higher temperature compared to corn syrup alone (>300° C.), and the resulting product was not pure platinum. EDS analysis showed the resulting product included platinum oxide, platinum chloride, and about 20% carbon.

Comparison with Cane Sugar Mixed with Dextrose

20% and 50% dextrose was added to the cane sugar, and these mixtures were used as the reducing agent in the reaction. The reaction started around 300° C. (as opposed to around 200° C. for the corn syrup). EDS analysis did not reveal any oxides or chlorides in the product. Carbon was still present at about 5%, which is lower than the level of carbon in the product following the use of pure cane sugar as the reducing agent.

When using corn syrup, the resulting platinum product is bright and shiny. (FIGS. 13A-13B.) In contrast, the products produced from the mixtures of cane sugar and dextrose are dull grey. (FIGS. 14-15.) Without wishing to be bound by theory, this is believed to be because of the residual carbon and the microstructure. As seen from the micrographs of the products (FIGS. 14A, 15A), the cane sugar platinum is weakly bonded with each grain, and shows severe porosity in the veins (see higher magnification images in FIGS. 14A, 15A compared to FIG. 13A). While this may be beneficial for some applications, it causes light to not reflect back and results in the platinum product being not as bright and shiny as the corn syrup product. Thus, corn syrup produces a product having a microstructure distinct from that produced from dextrose/cane sugar mixtures. However, the dextrose/cane sugar mixture still resulted in a foaming reaction that produced a high surface area product.

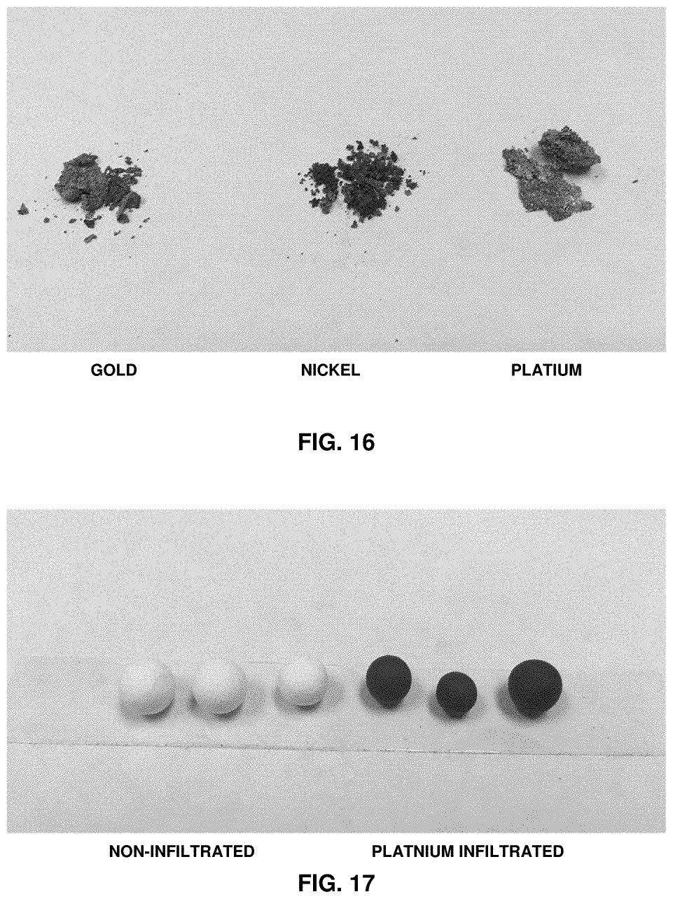

FIG. 16: Photograph showing that different metals are easily converted to porous metal. From left to right, are gold, nickel and platinum.

FIG. 17: Photograph showing how the presently described process is supported by a substrate. The platinum foam holds up to high flow rates of gas (or water); this image shows that a substrate can be used to support the porous structure while still benefiting from the high surface area. It also shows the uniformity that is easily achieved and the ease of infiltration of the platinum (or other) metal into such a substrate.

Certain embodiments of the compositions and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

1. A method of preparing a metal catalyst, the method comprising:
contacting at least one metal salt or a solution comprising the metal salt with a reducing agent comprising at least corn syrup to produce a reaction mixture;
optionally, boiling off at least some liquid present in the reaction mixture to alter the viscosity of the reaction mixture;
applying the reaction mixture to a substrate to produce a coated and/or infiltrated substrate;
heating the coated and/or infiltrated substrate to a temperature of at least about 200° C. for a period of time to produce a foamed metal catalyst.

2. (canceled)

3. (canceled)

4. (canceled)

5. (canceled)

6. (canceled)

7. The method of claim 1, wherein the metal salt comprises hexachloroplatinate or a nitrate salt; or, wherein the metal in the metal salt comprises platinum, palladium, silver, gold, nickel, copper, or oxides, alloys, or mixtures thereof.

8. The method of claim 1, wherein the metal catalyst further comprises at least one oxide.

9. The method of claim 8, wherein the oxide comprises cerium oxide, gadolinium oxide, or yttria stabilized zirconia.

10. The method of claim 1, wherein the metal catalyst comprises Ni-doped yttria stabilized zirconia.

11. The method of claim 1, wherein the metal catalyst comprises a mixture of two or more catalyst materials selected from the group consisting of platinum, palladium, nickel, silver, cerium oxide, gadolinium oxide, and yttria stabilized zirconia.

12. (canceled)

13. The method of claim 1, wherein the solution comprises methanol.

14. (canceled)

15. (canceled)

16. (canceled)

17. (canceled)

18. (canceled)

19. The method of claim 1, wherein the coated or infiltrated substrate is allowed to dry for a second period of time prior to the heating.

20. The method of claim 19, wherein the coated or infiltrated substrate is allowed to dry for about 2 hours at a temperature of about 80° C.

21. (canceled)

22. (canceled)

23. The method of claim 1, wherein the metal catalyst comprises a metal foam having a surface area of at least about 5 m²/g.

24. The method of claim 1, wherein the metal catalyst comprises a metal foam having a surface area of at least about 8 m²/g.

25. The method of claim 1, wherein the metal catalyst comprises a metal foam having a surface area of at least about 10 m²/g.

26. (canceled)

27. (canceled)

28. The method of claim 1, wherein the substrate comprises a metal, an alloy, a plastic, a solid electrolyte or a ceramic.

29. (canceled)

30. The method of claim 1, wherein the substrate comprises a ceramic material having a honeycomb structure.

31. (canceled)

32. (canceled)

33. (canceled)

34. (canceled)

35. (canceled)

36. (canceled)

37. A metal catalyst prepared by the method of claim 1.

38. A fuel cell comprising the metal catalyst of claim 37.

39. A catalytic converter comprising the metal catalyst of claim 37.

40. (canceled)

41. (canceled)

42. (canceled)

43. A method of preparing a catalyst, the method comprising:
contacting a metal salt or a solution comprising the metal salt with a reducing agent comprising a mixture of two or more sugars to produce a reaction mixture;
wherein the mixture of two or more sugars comprises a mixture of dextrose and cane sugar
optionally, boiling at least some liquid off the reaction mixture to alter the viscosity of the reaction mixture;
applying the reaction mixture to a substrate to produce a coated or infiltrated substrate; and
heating the coated or infiltrated substrate to a temperature of at least about 300° C. for a period of time to produce a metal catalyst.

44. (canceled)

45. The method of claim 43, wherein the mixture comprises about 20% dextrose.

46. The method of claim 43, wherein the mixture comprises about 50% dextrose.
